(19) United States
(12) Patent Application Publication
(10) Pub. No.: US 2007/0043624 A1
(43) Pub. Date: Feb. 22, 2007

(54) Method and device for preparing a mail

(75) Inventors: Bernd Meyer, Konigswinter (DE); Juergen Lang, Bergisch Gladbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DEUTSCHE POST AG, Bonn (DE)

(21) Appl. No.: 10/573,092

(22) PCT Filed: Sep. 16, 2004
(86) PCT No.: PCT/EP04/10400

§ 371 Date: Oct. 30, 2006

(30) Foreign Application Priority Data
Sep. 26, 2003 (DE) 103 45 056.4

(51) Int. Cl. G06Q 30/00

(52) U.S. Cl. 705/26; 705/410

(57) ABSTRACT

A method for preparing a mail, wherein task data for mail which is to be stamped and/or sent is produced in a task component. Electronically ordered data is received and the ordered data in address information of a receiver is separated and a goods identification code identifying the goods is also separated such that the goods identification code is transmitted to a warehouse management control unit. The disclosure also relates to the provision of address information in a form which can be lined to the goods, and to a suitable device for carrying out said method.

### FIELD OF THE INVENTION

The invention relates to a method for producing a postal item.

The invention also relates to a device that is suitable for carrying out the method.

### DESCRIPTION OF RELATED ART

A method of the generic type is known from the international patent application bearing the publication number WO 02/37425 A1. This publication discloses a method for providing postal items with postage indicia, mailing data being acquired in a first computer and the mailing data being processed in a second computer. In this process, the second computer generates individualized data for every single postal item as a function of the mailing data. The individualized data is incorporated into postage indicia whose printing is controlled by the first computer.

German preliminary published application DE 102 11 728 A1 discloses a method and a device for picking goods. Here, picking containers are transported under computer control to picking areas, and a warehouse management control unit transmits order data to a material flow control computer and the material flow control computer controls destinations of the picking containers in such a way that the picking containers are transported to picking areas where the goods to be picked are located.

The international patent application bearing the publication number WO 00/34899 A1 discloses an automatic auction procedure. In this auction procedure, bidding information from bidders is compared in an automated process, in which the maximum price that has been bid by the bidders is determined.

### SUMMARY OF THE INVENTION

The invention is based on the objective of further developing a method of the generic type in such a way that goods can be prepared for placement into the postal items.

According to the invention, this objective is achieved in conjunction with the generic part of claim 1 by the following steps:

receiving electronic order data;

breaking down the order data into address information of a recipient and a goods identification code;

preparing the address information in a form that can be linked to the goods;

linking the goods to the address information and

delivering the goods linked to the address information as a postal item.

It is advantageous to carry out the method in such a way that the goods identification code is transmitted to a warehouse management control unit.

An especially preferred embodiment of the invention is characterized in that a postage indicium is generated, taking into account the address information of the recipient.

The term “postage indicium” is not to be construed in any limiting fashion whatsoever. According to the invention, it encompasses known modalities of franking as well as other indicia that allow a further transport of the postal items or that substantiate a payment of the shipment of the postal items. Hence, in particular, the term “postage indicium” also encompasses delivery slips for postal items.

Moreover, it is advantageous for the order data to be stored in a transaction computer.

This embodiment of the invention allows an even more flexible use of the method as well as an even greater degree of automation.

An especially preferred embodiment of this is characterized in that the transaction computer performs an automatic comparison between the stock of goods and one or more pending orders.

Furthermore, it is advantageous for the warehouse management control unit to transmit the order data to the material flow control computer and for the material flow control computer to control the material flow in such a way that the goods and/or additional goods are placed into picking containers and/or directly into a transport container provided for the shipment as a postal item.

A likewise advantageous embodiment of the invention is achieved in that the transaction computer controls an automated auction procedure.

Moreover, it is advantageous to carry out the method in such a way that the transaction computer transmits the address information of the customer who placed the highest bid in the auction procedure to a computer of a seller who is offering the goods for sale at auction.

A combination of the postage indicium with the address information is especially advantageous.

In particular, it is advantageous to generate the franking information in such a way as is disclosed in German patents DE 100 20 561 C2, DE 100 20 563 C2 and DE 100 20 566 C2.

The incorporation of address information of a recipient as described in these patents has several advantages. For example, this makes it possible to ensure that the postage indicia are forgery-proof and to check the authenticity of the postage indicia in an automated process.

A preferred embodiment of the invention relates to a system and to a method for franking letters and parcels, whereby the franking system is connected to a goods management system in which shipment status and address information are stored.

According to an especially preferred embodiment of the invention, the system and the method are configured in such a way that the franking or freight identification of the shipment is controlled by the buyer of the goods, said buyer being identical to or designated by the recipient receiving all or part of the shipment.

In an especially preferred embodiment of the invention, franking systems are used that are concurrently used as addressing systems. Thus, if such systems are coupled to an addressing or goods management system, address information can be transmitted to the franking system and this address information can be printed out, for example, together with the franking in a joint printing process.

If the franking calls for the incorporation of elements of the recipient address, which is the case, for instance, with digital franking modalities such as PC franking, then, thanks to the coupling to the franking system, the necessary address elements can be transmitted.

If postal or logistics service providers require or remunerate a presorting of the postal items that have been dropped off for delivery, then, if a goods management system is coupled to a franking system, this can be effectuated by accessing sorting-relevant address information (e.g. postal code) and mailing information (e.g. dimensions/weight).

New possibilities for system and process integration have opened up with the introduction of digital franking methods such as, for example, PC franking (2001) or digital sender cancellation (2003).

Moreover, the invention can be combined with other digital franking methods. The presentation below with reference to the especially preferred PC franking is merely to be understood by way of example.

This presentation can also be applied to other digital franking methods.

In this context, the digital franking methods that incorporate information about the recipient address into the postage indicium are especially advantageous, although fundamentally, other digital franking methods can also be used.

PC franking makes it possible, for example, to combine the franking and addressing processes. First of all, the advantageous possibility exists to carry out the franking and addressing in one step and thus to save the separate process step of applying franking, for example, in the form of a cancellation or gluing of a postage stamp. Moreover, the combined franking and addressing by a computer system is used in order to incorporate parts of the address into the franking in order to increase the franking security. In the case of PC franking, for example, the postal code and six letters or numbers consisting of the street, house number or post office box are incorporated into the machine-readable matrix code of the franking. By cryptographically securing the data contents of the machine-readable matrix code, the incorporated information can be utilized within the scope of postal payment assurance in order to check the authenticity of the franking.

In an especially advantageous embodiment of the invention, the use of the PC franking translates into considerable process optimization when the autonomous franking process, for example, in a postal station, is eliminated. After all, if the possibilities of system integration are utilized and postal items or letters are also franked directly in one step during the computer-aided generation, then there is no longer a need for a dedicated postal station for outgoing mail.

The example of PC franking is suited for achieving an especially advantageous system integration. After all, if the address information of the recipient needed for the computer-aided generation of the postal item or letter is not entered into the system manually via a word-processing system but rather is taken from an electronic address book, then, in the case of individual postal items, the cooperation between word-processing, address book and franking system can achieve a marked process simplification. When mass mailings are to be generated on the basis of address information from an electronic address list, it is even possible to carry out mass franking operations.

If the franking system is coupled to a mail-producing system such as, for example, a goods management system having, for instance, an offer or invoice generation module, then franking can be carried out directly from the goods management system in that, when postal items are printed out, the necessary address information is transferred to the franking, which is produced at the same time.

The example of PC franking shows that the integration of the franking into a more comprehensive postal item production process eliminates the autonomy of the classic franking process, but embedding it into a larger process has more all-encompassing advantages. In particular, the indirect coupling of the franking system to an address database via a word-processing system or the direct coupling of the franking system to a goods management system gives rise to considerable process-related advantages.

Within the scope of the increasing integration of systems for generating postal items, goods management, franking and other systems of suppliers and final customers, a development is currently under way that eliminates the autonomy of the franking process in certain areas and embeds it into the process of postal item generation.

The result of the embedding of the franking is that the franking becomes a module that is controlled by the goods management system of the sender. When implemented in the software, this means that the procedure of franking with the transfer of the requisite parameters is called up by the goods management system and the result of the franking is received and processed by the goods management system. Since the entire control is carried out by the goods management system, the actual printing procedure of applying the postage indicium is often dispensed with within the scope of the franking. In solutions such as PC franking or IT franking, said postage indicium is generated as a data record in the franking module and sent to the goods management system as feedback. Only the goods management system controls—optionally in just one printing procedure—the combined print-out of the actual letter, the print-out of the recipient address and the print-out of the postage indicium.

Depending on the modality of franking, the parameters that are transferred by the goods management system to the franking module constitute information that goes into a part of the postage indicium that can be read in plain text or that is machine-readable, or else the constitute information from which the required information can be obtained. Thus, for example, methods are known in which the goods management system prescribes one of the most important parameters of a franking, namely, the franking value, and transfers it to the franking module. On the other hand, there are also “intelligent” franking modules that themselves determine the franking value of the postal item on the basis of transmitted postal item parameters such as the dimensions and the weight.

Another feature of modern digital franking systems such as PC franking, IT franking and digital sender cancellation is that non-postal information can normally be incorporated into the machine-readable part of a postage indicium. This non-postal data can be used by the sender, for example, to insert sorting information into the postage indicium so that the sender can “recognize” the postal item, even in the sealed state, after production and franking of the postal item, by reading out the machine-readable postage indicium and can appropriately sort and drop off the postal item. Another use of the non-postal data can be to embed information that allows the sender, for example, in case the postal item cannot be delivered, to take the appropriate steps without opening the returned postal item.

All of the processes of franking—regardless of whether the franking is generated autonomously in the traditional manner or whether it is embedded in an overarching process of postal item generation within the framework of the system integration—are characterized in that they are linear processes that start with the sender of a postal item and end at the recipient of the postal item. This fact is of significance since, precisely in the environment of electronic system integration, there are new possibilities for mapping closed ring processes.

Ring processes are characterized in that the initiator of a process is also the one that crucially affects the result of the process. The electronic mapping of ring processes has become possible owing to the networking of systems having different actors. In particular, the advent of the Internet promoted the possibility of technically simple and consistent networking between central systems (servers) and a large number of customer systems (clients as a rule).

A device according to the invention that is especially suitable for carrying out the method is characterized by the combination of the following features:

a means for receiving address information and a goods identification code that identifies the goods;

a means for storing the address information and the goods identification code;

a means for linking the goods to the address information and

a means to link the goods to the address information.

An especially preferred embodiment of this device is characterized in that the means to link the goods to the address information is a printer.

Another likewise advantageous embodiment of the device is configured in such a way that the means to link the goods to the address information is a transmitter that is designed in such a way that it can transmit the address information to a transponder that can be affixed to the goods.

The transponders that can be affixed to the goods can have various designs. In particular, miniaturizable transponders are suited for this purpose. Such transponders are preferably easy-to-make electronic circuits having a transmitter and/or receiver unit. In especially advantageous embodiments, these transponders do not have a power supply of their own but rather are activated by a brief supply of energy—especially in the form of electromagnetic radiation.

Additional advantages, special features and practical embodiments of the invention can be gleaned from the subordinate claims and from the presentation below of preferred embodiments making reference to the figures.

The drawings show the following:

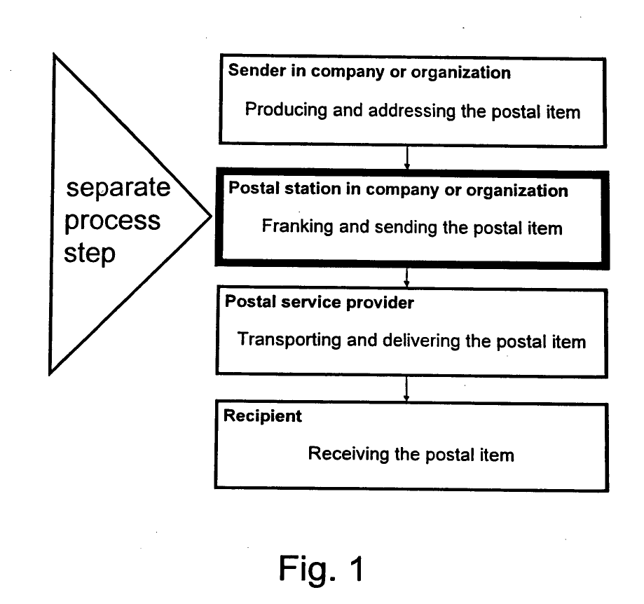

FIG. 1 a flow chart showing the production of a postal item with a separate franking step;

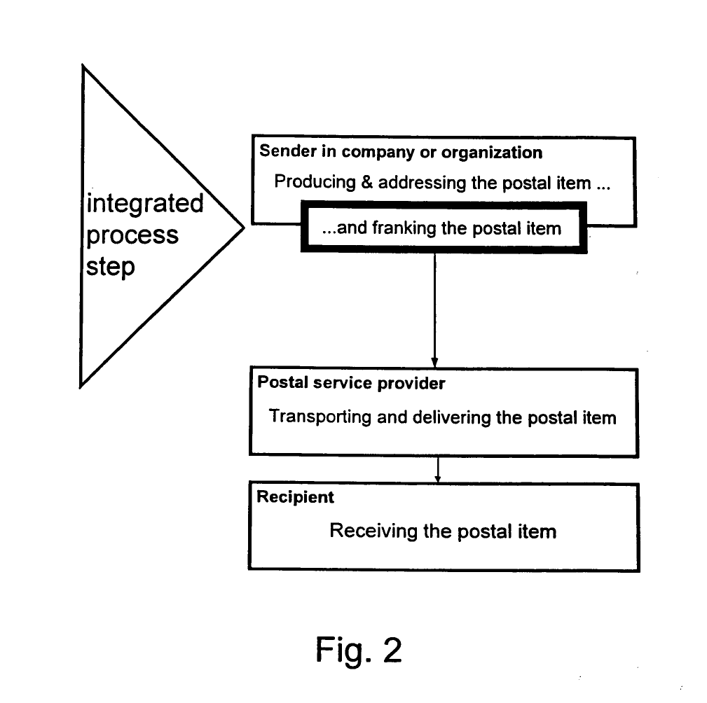

FIG. 2 a block diagram of a method according to the invention with a franking step integrated into the production and into the addressing of the postal item;

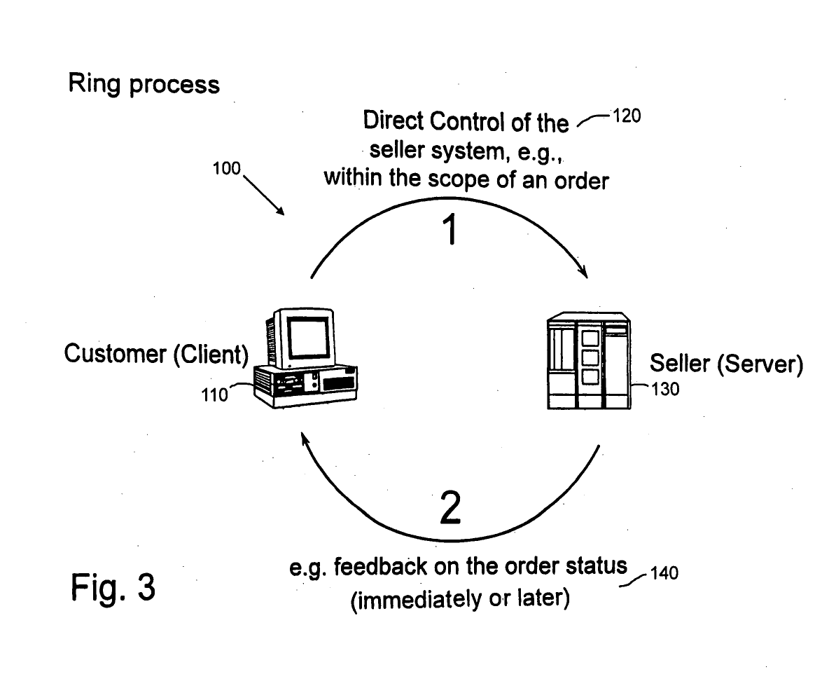

FIG. 3 the basic principle of a ring process used according to the invention;

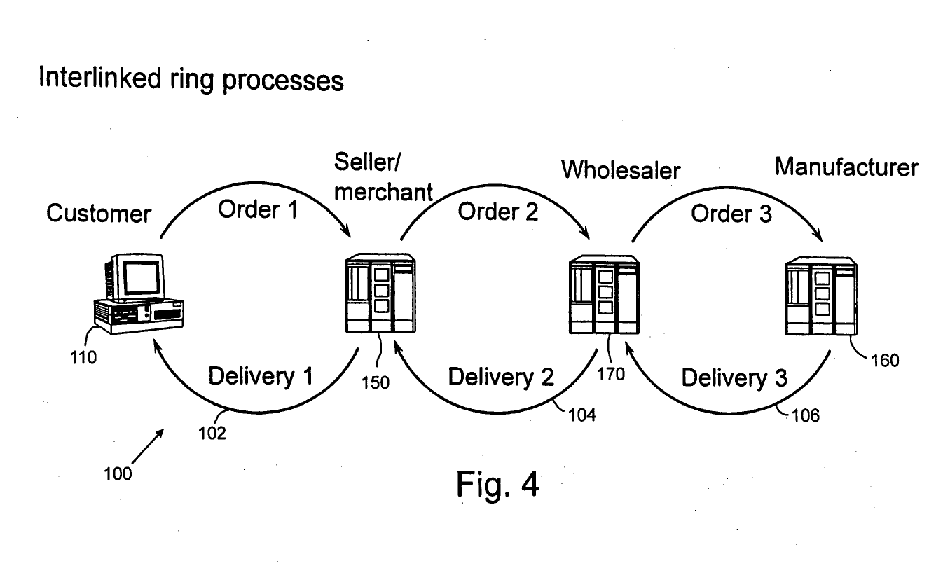

FIG. 4 a schematic diagram of a refinement of the ring process depicted in FIG. 3 to form interlinked ring processes.

In especially preferred examples, the ring processes are characterized in that the first process step starts, for example, with the customer of an on-line shop, with a person interested in some real estate or with a person interested in a product that is going to be auctioned. In contrast to traditional business models, here, it is such a customer or interested person who initiates an electronic process that has immediate effects on the electronic administration system of a seller. Without involvement on the part of the seller, a customer enters his/her complete master data into the administration system of the seller, expresses an interest to make a purchase or places a bid in an auction.

Through the system integration of the system of the customer (client) with the system of the seller (server), it is ultimately the customer who controls the goods management system of a seller from whom services are expected. If these services are actually performed by the seller and if the seller sends the customer an electronic message to this effect, then the circle, which is designated as the ring process, is closed. The figure below shows such a ring process.

Ring processes of this type are also referred to as “order-to-delivery” processes since an uninterrupted electronic (ring) process chain exists from the start of the process (order) initiated by the customer to the fulfillment of the performance (delivery). Electronic order-to-delivery ring processes are common nowadays in many large commercial organizations for purposes of ordering additional stock of products from the manufacturer.

If the ordering party is not an end customer but rather a merchant, it is generally the case that it is not client systems of the merchant that interact with server systems of the manufacturer or wholesaler but rather that goods management systems are used by both parties. In this case, the goods management system initiates a ring process of ordering goods from the manufacturer or wholesaler and, when the goods are delivered, said system likewise receives the delivery status transmitted electronically.

This translates into the possibility of interlinked ring processes that are currently being introduced at many companies and commercial organizations. A customer can, for example, start a first ring process by entering an order into the system of a seller or merchant and, optionally receiving a delivery status in return. This system of the merchant/seller, in turn, orders the goods in a second electronic ring process from the system of the wholesaler, which then, if applicable, opens a third ring process for placing an order from the manufacturer.

An especially preferred embodiment of the invention is characterized in that franking—in the sense of an electronically mapped ring process—is initiated and/or controlled by the recipient of a postal item. In this manner, effects of process optimization can also be utilized in the realm of franking.

Advantageously, the method is carried out in such a way that it is controlled via a goods management system.

In this context, it is advantageous for the shipment status administered in the goods management system to be utilized and updated for control purposes.

Advantageously, the method is carried out in such a way that the system of the recipient initiating the franking process, the goods management system of the seller and the franking system for electronic data exchange are all connected to each other via data networks.

It is advantageous for the recipient of a postal item to control the franking by specifying the desired postal service provider or the desired postal service.

Here, it is advantageous for the franking system to interact with the recipient to offer selectable alternatives in terms of the postal service provider or the desired postal service.

It is advantageous for the recipient of a postal item to control the franking by transmitting postal and recipient-related information to the franking system.

Here, it is advantageous for the franking system to ascertain the completeness and correctness of the postal and recipient-related information and to transmit the result to the recipient.

It is advantageous for the recipient of a postal item to control the franking by triggering or authorizing the franking.

An advantageous embodiment of the method and a preferred embodiment of the system are characterized in that the franking system functions asynchronously as a buffer, making use of the in-line arrangement of the goods management system.

It is advantageous for the franking system to inform the recipient that the franking has been carried out.

1. A method for producing a postal item, whereby order data for a postal item that is to be printed and/or sent is generated in an order component, comprising the following steps:
receiving electronic order data;
breaking down the order data into address information of a recipient and a goods identification code;
preparing the address information in a form that can be linked to the goods;
linking the goods to the address information, and
delivering the goods linked to the address information as a postal item.

2. The method according to claim 1,
comprising generating a postage indicium based on the address information of the recipient.

3. The method according to claim 1, comprising storing the order data in a transaction computer.

4. The method according to claim 3,
comprising the transaction computer performing an automatic comparison between the stock of goods and one or more pending orders.

5. The method according to claim 3, comprising a warehouse management control unit transmitting the order data to a material flow control computer and the material flow control computer controlling material flow in such a way that the goods and/or additional goods are placed into picking containers and/or directly into a transport container provided for the shipment as a postal item.

6. The method according to claim 3, comprising the transaction computer controlling an automated auction procedure.

7. The method according to claim 6,
wherein the transaction computer transmits the address information of the customer who placed the highest bid in the auction procedure to a computer of a seller who is offering the goods for sale at auction.

8. The method according to claim 1, comprising generating a postage indicium for the postal item in an automated process.

9. The method according to claim 8, comprising controlling the generation of the postage indicium by a warehouse management control unit.

10. The method according to claim 8,
comprising controlling the generation of the postage indicium by a computer of the recipient.

11. The method according to claim 8, comprising notifying the recipient of the execution of the franking.

12. A device for generating a postal item,
comprising, in combination:
a computer for receiving and storing address information and a goods identification code that identifies the goods;
a means for linking the goods to the address information, and
a postal service provider for delivering the goods linked to the address information as a postal item.

13. The device according to claim 12,
wherein the means to link the goods to the address information is a printer.

14. The device according to claim 12,
wherein the means to link the goods to the address information is a transmitter that is designed in such a way that it can transmit the address information to a transponder that can be affixed to the goods.
